(19) United States
(12) Patent Application Publication
(10) Pub. No.: US 2025/0319699 A1
(43) Pub. Date: Oct. 16, 2025

(54) LIQUID EJECTING APPARATUS

(71) Applicant: SEIKO EPSON CORPORATION, Tokyo (JP)

(72) Inventors: Kota MORI, SHIOJIRI-SHI (JP); Takashi TAMAI, SUWA-SHI (JP)

(21) Appl. No.: 19/087,700

(22) Filed: Mar. 24, 2025

(30) Foreign Application Priority Data
Mar. 27, 2024 (JP) 2024-051753

(51) Int. Cl. B41J 2/145; B41J 2/21; B41J 25/00

(52) U.S. Cl. CPC B41J 2/145; B41J 2/2117; B41J 25/001

(57) ABSTRACT

A liquid ejecting apparatus includes: a first head chip having a first nozzle row and a second nozzle row; a second head chip having a third nozzle row and a fourth nozzle row; and a movement mechanism moving relative positions of the first and second head chips and a printing medium along a second axis. The first to fourth nozzle rows are parallel to a third axis intersecting the second axis. Positions of the nozzles of the first nozzle row the nozzles of the fourth nozzle row along a seventh axis orthogonal to a second axis are shifted by half a pitch. The first and fourth nozzle rows eject a first liquid. Positions of the nozzles of the second nozzle row and the nozzles of the third nozzle row along the seventh axis are shifted by half a pitch. The second and third nozzle rows eject a second liquid.

The present application is based on, and claims priority from JP Application Serial Number 2024-051753, filed Mar. 27, 2024, the disclosure of which is hereby incorporated by reference herein in its entirety.

### BACKGROUND

### 1. Technical Field

The present disclosure relates to a liquid ejecting apparatus.

### 2. Related Art

A liquid ejecting apparatus that ejects a liquid such as ink onto a medium such as printing paper has been proposed.

A liquid ejecting apparatus described in JP-A-2014-156045 includes a head including a plurality of nozzle rows that eject ink. In such a liquid ejecting apparatus, a density of a plurality of nozzles, a width of the nozzle row, and a distance between the nozzle rows are configured to inhibit ink mist caused by droplet ejection from the nozzles from adhering to a nozzle plate.

In recent years, there has been a demand for arranging nozzles at an even higher density to print a high-resolution image at a high speed. In this case, when the distance between the nozzle rows is shortened to increase the density of the nozzles in the configuration according to the related art, there is a possibility that wind ripples easily occur. In particular, when a distance between two nozzle rows that eject ink of the same color is shortened, there is a possibility that wind ripples easily occur. However, when the distance between two adjacent nozzle rows is configured to arrange the nozzles at a high density while suppressing the occurrence of the wind ripples, it is difficult to reduce a size of the head.

### SUMMARY

According to an aspect of the present disclosure, a liquid ejecting apparatus includes: a liquid ejecting head including a plurality of head chips that eject a liquid toward a medium along a first axis; and a movement mechanism moving relative positions of the liquid ejecting head and the medium along a second axis intersecting the first axis, in which the plurality of head chips include a first head chip and a second head chip arranged on one side of the first head chip, the first head chip includes a first nozzle row in which a plurality of nozzles are arranged along a third axis intersecting the first axis and the second axis, and a second nozzle row in which a plurality of nozzles are arranged along a fourth axis parallel to the third axis, the second head chip includes a third nozzle row in which a plurality of nozzles are arranged along a fifth axis parallel to the third axis, and a fourth nozzle row in which a plurality of nozzles are arranged along a sixth axis parallel to the third axis, positions of the plurality of nozzles of the first nozzle row and the plurality of nozzles of the fourth nozzle row along a seventh axis orthogonal to the second axis are shifted by half a pitch, the plurality of nozzles of the first nozzle row and the plurality of nozzles of the fourth nozzle row eject a first liquid, positions of the plurality of nozzles of the second nozzle row and the plurality of nozzles of the third nozzle row along the seventh axis are shifted by half a pitch, and the plurality of nozzles of the second nozzle row and the plurality of nozzles of the third nozzle row eject a second liquid of a type different from the first liquid.

### BRIEF DESCRIPTION OF THE DRAWINGS

FIG. 1 is a schematic diagram illustrating a configuration example of a liquid ejecting apparatus according to a first embodiment.

FIG. 2 is a bottom view of a liquid ejecting head illustrated in FIG. 1.

FIG. 3 is a view illustrating some of a plurality of head chips illustrated in FIG. 2.

FIGS. 4A to 4E are views for describing examples of liquids ejected from the head chips included in respective head units illustrated in FIG. 2.

FIG. 5 is a view illustrating some of the plurality of head chips included in the head unit.

FIG. 6 is a view illustrating some of the plurality of head chips included in the head unit.

FIG. 7 is a bottom view schematically illustrating a head chip in a second embodiment.

FIG. 8 is a view illustrating some of the plurality of head chips in the second embodiment.

FIGS. 9A to 9E are views for describing examples of liquids ejected from the head chips included in respective head units in the second embodiment.

FIG. 10 is a view illustrating some of a plurality of head chips in a first modification.

### DESCRIPTION OF EMBODIMENTS

Hereinafter, exemplary embodiments according to the present disclosure will be described with reference to the accompanying drawings. Note that the dimensions and the scale of each component may differ appropriately from actual dimensions and scale, and some portions are schematically illustrated in the drawings to facilitate understanding. Further, the scope of the present disclosure is not limited to the embodiments unless otherwise specified in the following description.

In the following description, an X axis, a Y axis, and a Z axis that intersect one another are appropriately used. Hereinafter, a direction along the X axis is referred to as an X1 direction, and a direction opposite to the X1 direction is referred to as an X2 direction. Similarly, directions opposite to each other along the Y axis are a Y1 direction and a Y2 direction. Directions opposite to each other along the Z axis are a Z1 direction and a Z2 direction. Typically, the Z axis is a vertical axis, and the Z1 direction corresponds to a downward direction in a vertical direction. However, the Z axis does not have to be a vertical axis. Further, the X axis, the Y axis, and the Z axis are typically orthogonal to each other. In the following description, an α axis and a β axis that intersect the X axis, the Y axis, and the Z axis and are mutually orthogonal to each other are used as appropriate. A direction along the α axis is referred to as an α1 direction, and a direction opposite to the α1 direction is referred to as an α2 direction. Similarly, directions opposite to each other along the β axis are a β1 direction and a β2 direction.

In the present specification, an expression “different types of liquids” refers to liquids that are different in at least one of color, material, and use. In addition, an expression “elements u and w are shifted by half a pitch” means that the elements u and w are shifted by half the width of each of the elements u and w. The expression “being shifted by half a pitch” is not strictly limited to “being shifted by half the width”, but includes a manufacturing error, an assembly error, and the like. In the following embodiments, a “first axis” corresponds to the Z axis, a “second axis intersecting the first axis” corresponds to the Y axis, and a “seventh axis orthogonal to the second axis” corresponds to the X axis.

### A. First Embodiment

### A1. Liquid Ejecting Apparatus 100

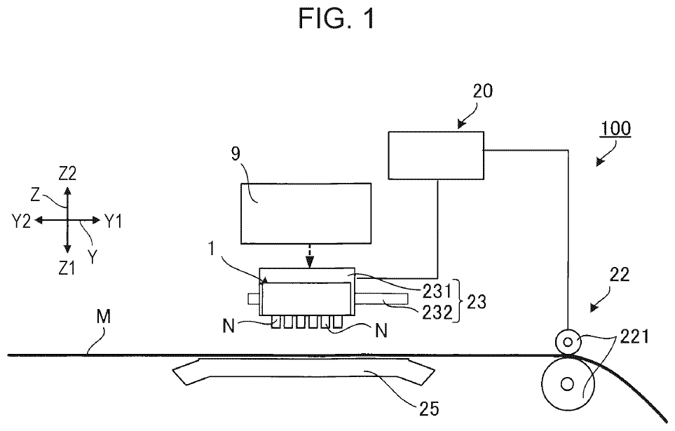

FIG. 1 is a schematic diagram illustrating a configuration example of a liquid ejecting apparatus 100 according to a first embodiment. The liquid ejecting apparatus 100 illustrated in FIG. 1 is an ink jet printing apparatus that ejects a liquid as a droplet onto a medium M. The medium M is a printing target of any material, such as printing paper, a resin film, or fabric.

As illustrated in FIG. 1, the liquid ejecting apparatus 100 includes a liquid container 9, a control unit 20, a movement mechanism 22, a movement mechanism 23, a support member 25, and a liquid ejecting head 1.

The liquid container 9 stores the liquid. Specific aspects of the liquid container 9 include, for example, a cartridge that is attachable to and detachable from the liquid ejecting apparatus 100, a bag-shaped liquid pack made of a flexible film, and a liquid tank that can be refilled with the liquid.

The control unit 20 controls an operation of each element of the liquid ejecting apparatus 100. The control unit 20 includes, for example, one or a plurality of processing circuits such as a central processing unit (CPU) and a field programmable gate array (FPGA), and one or a plurality of storage circuits such as a semiconductor memory.

The movement mechanism 22 transports the medium M in the Y2 direction under the control of the control unit 20. The movement mechanism 22 includes a transport roller 221 that transports the medium M. The movement mechanism 23 reciprocates the liquid ejecting head 1 along the Y axis under the control of the control unit 20. For example, the liquid ejecting head 1 is moved in the Y1 direction when ejecting the liquid, and the liquid ejecting head 1 is moved in the Y2 direction each time the movement in the Y1 direction is completed. The movement mechanism 23 includes a substantially box-shaped carriage 231 that accommodates the liquid ejecting head 1, and an endless transport belt 232 to which the carriage 231 is fixed. The movement mechanisms 22 and 23 move relative positions of the liquid ejecting head 1 and the medium M along the Y axis. For example, the movement mechanism 23 may be omitted.

The number of liquid ejecting heads 1 mounted on the carriage 231 is not limited to one, and may be plural. In addition to the liquid ejecting head 1, the above-described liquid container 9 may be mounted on the carriage 231.

The liquid ejecting head 1 ejects the liquid supplied from the liquid container 9 onto the medium M from a plurality of nozzles N under the control of the control unit 20. The ejection is performed in parallel with the transport of the medium M by the movement mechanism 22 and the movement of the liquid ejecting head 1 by the movement mechanism 23, thereby forming an image on the surface of the medium M.

### A2. Liquid Ejecting Head 1

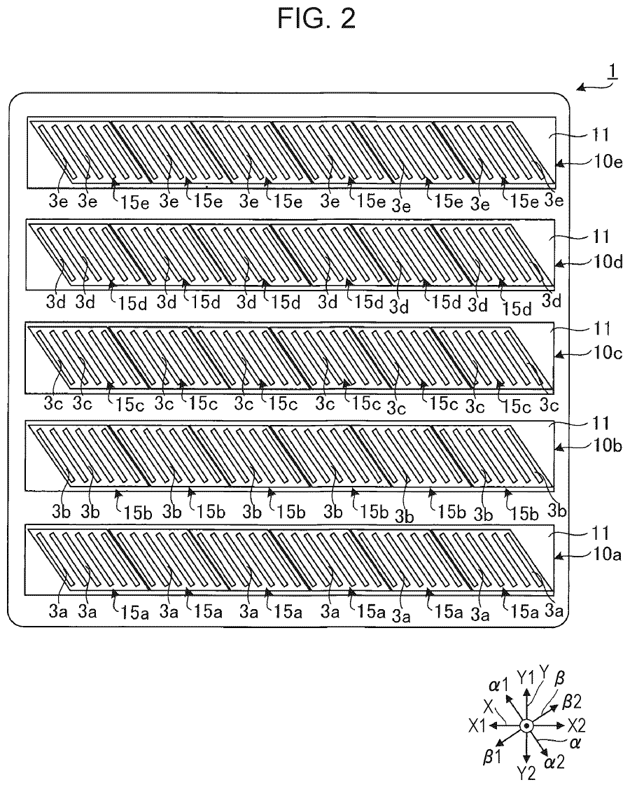

FIG. 2 is a bottom view of the liquid ejecting head 1 illustrated in FIG. 1. The liquid ejecting head 1 illustrated in FIG. 2 includes five head units 10a, 10b, 10c, 10d, and 10e as a plurality of head units 10.

The head units 10a, 10b, 10c, 10d, and 10e are spaced apart from each other and arranged in the Y1 direction. Therefore, each head unit 10 includes a holder 11 and a plurality of chip group modules 15. The holder 11 has an elongated shape extending along the X axis. The holder 11 is a member that holds the plurality of chip group modules 15.

The head unit 10a includes six chip group modules 15a. The head unit 10b includes six chip group modules 15b. The head unit 10c includes six chip group modules 15c. The head unit 10d includes six chip group modules 15d. The head unit 10e includes six chip group modules 15e. The plurality of chip group modules 15 included in each head unit 10 are arranged along the X axis.

Each chip group module 15 includes six head chips 3 that are spaced apart from each other and arranged along the X axis. Specifically, each chip group module 15a includes six head chips 3a. Each chip group module 15b includes six head chips 3b. Each chip group module 15c includes six head chips 3c. Each chip group module 15d includes six head chips 3d. Each chip group module 15e includes six head chips 3e. As described above, the liquid ejecting head 1 includes a plurality of head chips 3, 180 head chips 3 in the illustrated example.

Each head chip 3 ejects ink toward the above-described medium M in the Z1 direction along the Z axis as the “first axis”. Although not illustrated in detail, each head chip 3 includes a plurality of nozzles N and a driving element such as a piezoelectric element that causes each nozzle N to eject the liquid. Furthermore, each head chip 3 includes a reservoir that stores the liquid supplied from the liquid container 9 and supplies the liquid to the nozzle N, and a flow path through which the ink flows from the reservoir to the nozzle.

### A3. Head Chip 3

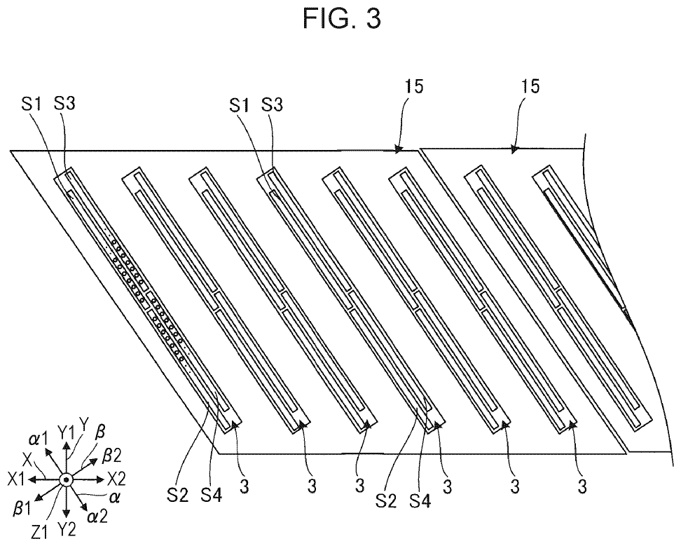

FIG. 3 is a view illustrating some of the plurality of head chips 3 illustrated in FIG. 2. As illustrated in FIG. 3, the plurality of head chips 3 are spaced apart from each other in the direction along the X axis, for example, at equal intervals. Each head chip 3 includes the plurality of nozzles N. The nozzle N is a space through which the ink is ejected. The plurality of nozzles N are arranged in two rows along the α axis at intervals. The plurality of nozzles N arranged in this way are divided into four nozzle rows S1, S2, S3, and S4. Each nozzle row S is a set of a plurality of nozzles N linearly arranged along the α axis. In each drawing, each nozzle row S is illustrated as a square frame to facilitate understanding.

The plurality of nozzles N belonging to each nozzle row S are arranged in one row at equal intervals. Opening areas of the respective nozzles N are equal to each other. The four nozzle rows S1 to S4 included in a single head chip 3 are arranged in two rows along the β axis and two columns along the α axis. A row direction of each nozzle row S is the direction along the α axis.

In each head chip 3, the plurality of nozzles N are arranged in a direction that intersects the X axis and the Y axis when viewed in the Z1 direction, in which a liquid is ejected. Therefore, the plurality of nozzles N are arranged in a direction intersecting a direction in which the medium M and the liquid ejecting head 1 move when viewed in the Z1 direction. Further, the row direction of each of the four nozzle rows S1, S2, S3, and S4 intersects the X axis and the Y axis when viewed in the Z1 direction. Therefore, the row direction of each of the four nozzle rows S1, S2, S3, and S4 intersects the direction in which the medium M and the liquid ejecting head 1 move when viewed in the Z1 direction.

In each head chip 3, the nozzle row S1 is provided in the α1 direction with respect to the nozzle row S2, and is positioned in the β1 direction with respect to the nozzle row S3. The nozzle row S4 is provided in the β2 direction with respect to the nozzle row S2, and is positioned in the α2 direction with respect to the nozzle row S3.

### A4. Example of Liquid in Each Nozzle Row S

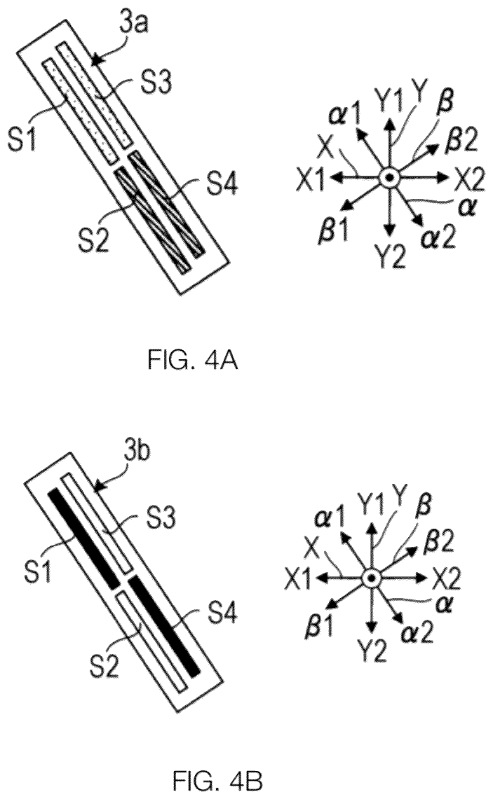

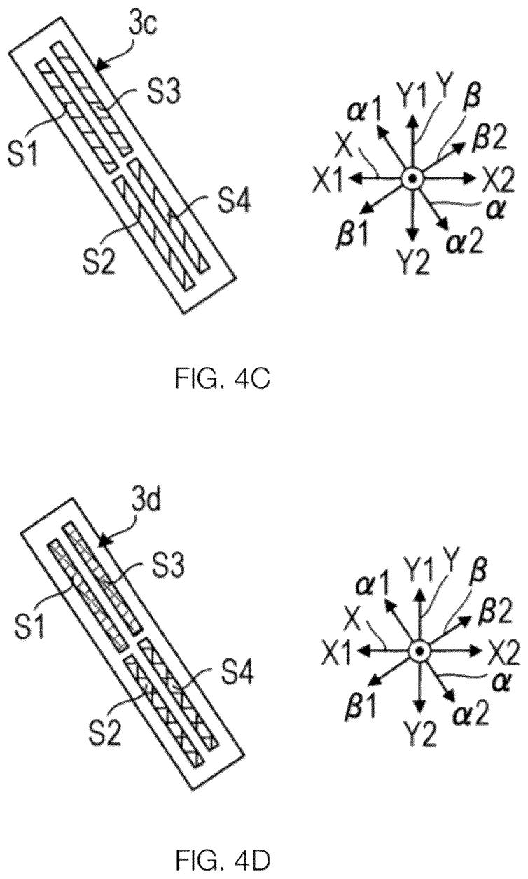

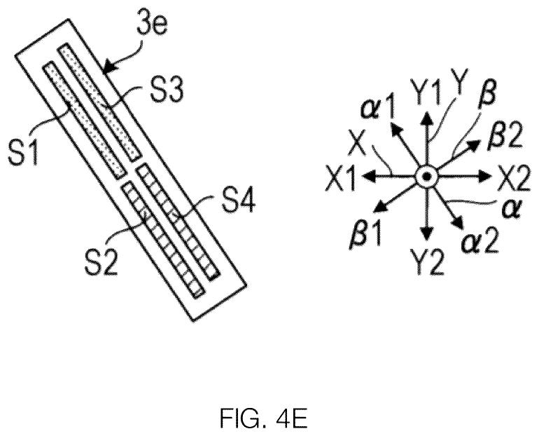

FIGS. 4A to 4E are views for describing examples of the liquids ejected from the head chips 3 included in the respective head units 10 illustrated in FIG. 2. Any type of liquid may be stored in the liquid container 9 in FIG. 1 described above, and any type of liquid may be supplied from the liquid container 9 to each head chip 3 included in the liquid ejecting head 1. FIGS. 4A to 4E illustrate examples of the type of the liquid supplied to the liquid ejecting head 1. In FIGS. 4A to 4E, different hatching is used for each type of liquid to facilitate understanding.

In the present embodiment, a different liquid is supplied to each head unit 10. An example of the type of the liquid in the plurality of head chips 3 belonging to each head unit 10 is the same. FIG. 4A illustrates the head chip 3a included in the head unit 10a. FIG. 4B illustrates the head chip 3b included in the head unit 10b. FIG. 4C illustrates the head chip 3c included in the head unit 10c. FIG. 4D illustrates the head chip 3d included in the head unit 10d. FIG. 4E illustrates the head chip 3e included in the head unit 10e.

In the head chip 3a illustrated in FIG. 4A, the same liquids are ejected from the respective nozzles N belonging to the nozzle row S1 and the nozzle row S3, and the same liquids are ejected from the respective nozzles N belonging to the nozzle row S2 and the nozzle row S4. For example, a reaction liquid for a paper medium is ejected from the nozzle rows S1 and S3 of the head chip 3a. The reaction liquid is used when the medium M is paper, and contains, for example, a coagulant that instantly coagulates coloring material components in the liquid. For example, a reaction liquid for a film-based medium is ejected from the nozzle rows S2 and S4 of the head chip 3a. The reaction liquid is used when the medium M is a resin film such as polyethylene terephthalate (PET), and contains, for example, a coagulant that instantly coagulates coloring material components in the liquid.

In the head chip 3b illustrated in FIG. 4B, the same liquids are ejected from the respective nozzles belonging to the nozzle row S1 and the nozzle row S4, and the same liquids are ejected from the respective nozzles belonging to the nozzle row S2 and the nozzle row S3. For example, black ink is ejected as a “second liquid” from the nozzle rows S1 and S4 of the head chip 3b. White ink is ejected as a “first liquid” from the nozzle rows S2 and S3 of the head chip 3b.

In the head chip 3c illustrated in FIG. 4C, the same liquids are ejected from the respective nozzles belonging to the nozzle row S1 and the nozzle row S3, and the same liquids are ejected from the respective nozzles belonging to the nozzle row S2 and the nozzle row S4. Green ink is ejected from the nozzle rows S1 and S3 of the head chip 3c. Cyan ink is ejected from the nozzle rows S2 and S4 of the head chip 3c.

In the head chip 3d illustrated in FIG. 4D, the same liquids are ejected from the respective nozzles belonging to the nozzle row S1 and the nozzle row S3, and the same liquids are ejected from the respective nozzles belonging to the nozzle row S2 and the nozzle row S4. Orange ink is ejected from the nozzle rows S1 and S3 of the head chip 3d. Magenta ink is ejected from the nozzle rows S2 and S4 of the head chip 3d.

In the head chip 3e illustrated in FIG. 4E, the same liquids are ejected from the respective nozzles belonging to the nozzle row S1 and the nozzle row S3, and the same liquids are ejected from the respective nozzles belonging to the nozzle row S2 and the nozzle row S4. An overprint liquid is ejected from the nozzle rows S1 and S3 of the head chip 3e. The overprint liquid is, for example, a coating liquid used to improve fixability of the liquid to the medium M. Yellow ink is ejected from the nozzle rows S2 and S4 of the head chip 3e.

The ink includes a coloring material or a dye. The type of the ink in each head chip 3 is not limited to the examples in FIGS. 4A to 4E and any type of ink may be used.

As described above, in the head chips 3a, 3c, 3d, and 3e, the same liquids are ejected from the respective nozzles belonging to the nozzle rows S1 and S3, and the same liquids are ejected from the respective nozzles belonging to the nozzle rows S2 and S4. Therefore, in the head units 10a, 10c, 10d, and 10e, the plurality of head chips 3 arranged along the X axis eject the same type of liquid.

On the other hand, in the head chip 3b, the same liquids are ejected from the respective nozzles belonging to the nozzle rows S1 and S4, and the same liquids are ejected from the respective nozzles belonging to the nozzle rows S2 and S3. Therefore, in the head unit 10b, two types of ink are alternately arranged along the X axis.

### A5. Arrangement of Nozzles N in Head Chip 3b

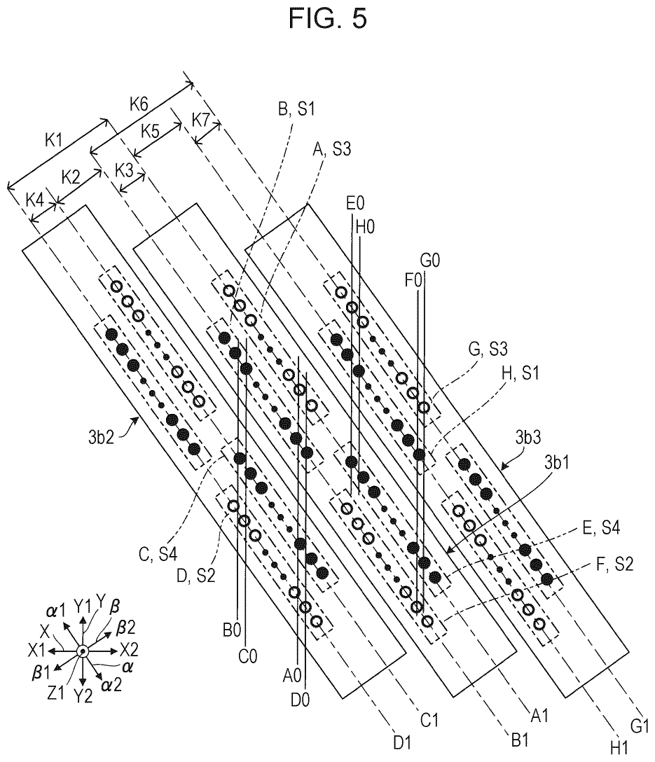

FIG. 5 is a view illustrating some of the plurality of head chips 3b included in the head unit 10b. In FIG. 5, the nozzles N are colored differently depending on the type of the liquid to be ejected to facilitate understanding. Specifically, in FIG. 5, the nozzles N that eject the white ink are illustrated in white, and the nozzles N that eject the black ink are illustrated in black.

As illustrated in FIG. 5, among the plurality of head chips 3b included in the head unit 10b, any one of the head chips 3b is referred to as a “first head chip 3b1”. The middle head chip 3b of three head chips 3b illustrated in FIG. 5 is the first head chip 3b1. The head chip 3b arranged on one side of the first head chip 3b1 in the X1 direction is referred to as a “second head chip 3b2”. The head chip 3b arranged on the other side of the first head chip 3b1 in the X2 direction is referred to as a “third head chip 3b3”.

There is no other head chip 3b between the first head chip 3b1 and the second head chip 3b2, and the first head chip 3b1 and the second head chip 3b2 are adjacent to each other. Similarly, there is no other head chip 3b between the first head chip 3b1 and the third head chip 3b3, and the first head chip 3b1 and the third head chip 3b3 are adjacent to each other. The third head chip 3b3, the first head chip 3b1, and the second head chip 3b2 are arranged in this order in the β1 direction without any other head chips 3b between the third head chip 3b3, the first head chip 3b1, and the second head chip 3b2 while being spaced apart from each other.

Furthermore, in the first head chip 3b1, the nozzle row S3 is a “first nozzle row A”, the nozzle row S1 is a “second nozzle row B”, the nozzle row S4 is a “fifth nozzle row E”, and the nozzle row S2 is a “sixth nozzle row F”. In the second head chip 3b2, the nozzle row S4 is a “third nozzle row C”, and the nozzle row S2 is a “fourth nozzle row D”. In the third head chip 3b3, the nozzle row S3 is a “seventh nozzle row G”, and the nozzle row S1 is an “eighth nozzle row H”.

The first nozzle row A, the second nozzle row B, the third nozzle row C, and the fourth nozzle row D are arranged in this order in the Y2 direction, which is a transport direction of the liquid ejecting head 1. From another perspective, the second nozzle row B and the third nozzle row C are interposed between the first nozzle row A and the fourth nozzle row D on the Y axis.

In addition, in the first nozzle row A, a plurality of nozzles N are arranged along a third axis A1 intersecting the first axis and the second axis. In the second nozzle row B, a plurality of nozzles N are arranged along a fourth axis B1 parallel to the third axis A1. In the third nozzle row C, a plurality of nozzles N are arranged along a fifth axis C1 parallel to the third axis A1. In the fourth nozzle row D, a plurality of nozzles N are arranged along a sixth axis D1 parallel to the third axis A1. The third axis A1, the fourth axis B1, the fifth axis C1, and the sixth axis D1 are arranged in this order in the Y2 direction, which is the transport direction of the liquid ejecting head 1.

As described above, the plurality of nozzles N of the first nozzle row A and the plurality of nozzles N of the fourth nozzle row D eject the white ink as the “first liquid”. The plurality of nozzles N of the second nozzle row B and the plurality of nozzles N of the third nozzle row C eject the black ink as the “second liquid of a type different from the first liquid”.

Positions of the plurality of nozzles N of the first nozzle row A and the plurality of nozzles N of the fourth nozzle row D along the X axis, which is the seventh axis orthogonal to the second axis, are shifted by half a pitch. A line segment A0 along the Y axis passing through the center of any one of the plurality of nozzles N of the first nozzle row A when viewed in the Z1 direction, and a line segment D0 along the Y axis passing through the center of any one of the plurality of nozzles N of the fourth nozzle row D when viewed in the Z1 direction are illustrated to facilitate understanding. Positions of the line segments A0 and D0 along the X axis are shifted. For example, when a straight line along the X axis is printed on the medium M by droplets ejected from the plurality of nozzles N of the first nozzle row A and droplets ejected from the plurality of nozzles N of the fourth nozzle row D, dots formed by the droplets ejected from the plurality of nozzles N of the first nozzle row A and dots formed by the droplets ejected from the plurality of nozzles N of the fourth nozzle row D are printed so as to be alternately arranged along the X axis.

Positions of the plurality of nozzles N of the second nozzle row B and the plurality of nozzles N of the third nozzle row C along the X axis, which is the “seventh axis”, are shifted by half a pitch. A line segment B0 along the Y axis passing through the center of any one of the plurality of nozzles N of the second nozzle row B when viewed in the Z1 direction, and a line segment C0 along the Y axis passing through the center of any one of the plurality of nozzles N of the third nozzle row C when viewed in the Z1 direction are illustrated. Positions of the line segments B0 and C0 along the X axis are shifted. For example, when a straight line along the X axis is printed on the medium M by droplets ejected from the plurality of nozzles N of the second nozzle row B and droplets ejected from the plurality of nozzles N of the third nozzle row C, dots formed by the droplets ejected from the plurality of nozzles N of the second nozzle row B and dots formed by the droplets ejected from the plurality of nozzles N of the third nozzle row C are printed so as to be alternately arranged along the X axis.

Whether or not to perform ejection from the plurality of nozzles N belonging to the first nozzle row A, the second nozzle row B, the third nozzle row C, and the fourth nozzle row D is selected as appropriate, and for example, a desired color is formed on the medium M. For example, a single ruled line is formed on the medium M by the liquids ejected from the plurality of nozzles N belonging to the first nozzle row A, the second nozzle row B, the third nozzle row C, and the fourth nozzle row D.

For example, a resolution in the direction along the X axis achieved by the liquid ejected from the plurality of nozzles N belonging to the first nozzle row A is 600 dpi, and a resolution in the direction along the X axis achieved by the liquid ejected from the plurality of nozzles N belonging to the fourth nozzle row D is 600 dpi. In this case, the plurality of nozzles N of the first nozzle row A and the plurality of nozzles N of the fourth nozzle row D are shifted by half a pitch on the X axis, so that the first nozzle row A and the fourth nozzle row D can achieve a resolution of 1200 dpi together. Therefore, the first nozzle row A and the fourth nozzle row D can form a ruled line with a resolution of 1200 dpi on the medium M.

Similarly, for example, a resolution in the direction along the X axis achieved by the liquid ejected from the plurality of nozzles N belonging to the second nozzle row B is 600 dpi, and a resolution in the direction along the X axis achieved by the liquid ejected from the plurality of nozzles N belonging to the third nozzle row C is 600 dpi. In this case, the plurality of nozzles N of the second nozzle row B and the plurality of nozzles N of the third nozzle row C are shifted by half a pitch on the X axis, so that the second nozzle row B and the third nozzle row C can achieve a resolution of 1200 dpi together. Therefore, the second nozzle row B and the third nozzle row C can form a ruled line with a resolution of 1200 dpi on the medium M.

As described above, in the first nozzle row A and the fourth nozzle row D that eject the same “first liquid”, the plurality of nozzles N of the first nozzle row A and the plurality of nozzles N of the fourth nozzle row D are shifted by half a pitch on the X axis, and thus, the resolution can be increased. Similarly, in the second nozzle row B and the third nozzle row C that eject the same “second liquid”, the plurality of nozzles N of the second nozzle row B and the plurality of nozzles N of the third nozzle row C are shifted by half a pitch on the X axis, and thus, the resolution can be increased.

Furthermore, as illustrated in FIG. 5, an interval K1 between the third axis A1 and the sixth axis D1 is larger than each of an interval K3 between the third axis A1 and the fourth axis B1 and an interval K4 between the fifth axis C1 and the sixth axis D1. For this reason, the same liquids ejected from the respective nozzles of the first nozzle row A and the fourth nozzle row D are less likely to be influenced by each other than, for example, the same liquids ejected from the respective nozzles of the first nozzle row A and the second nozzle row B. Therefore, even when solid printing is performed while high-resolution printing is enabled by arranging the first nozzle row A and the fourth nozzle row D so as to be shifted by half a pitch such that the same liquids are ejected from the first nozzle row A and the fourth nozzle row D to form a single ruled line, it is possible to decrease a possibility of occurrence of wind ripples on the medium M due to the liquids ejected from the first nozzle row A and the fourth nozzle row D. Then, since the interval K1 is larger than the interval K3, even when the intervals K1 and K3 are decreased by increasing a density of the nozzles N, the occurrence of the wind ripples can be suppressed. Therefore, it is possible to avoid a difficulty in size reduction of the liquid ejecting head 1 due to the suppression of the wind ripples.

Further, an interval K2 between the fourth axis B1 and the fifth axis C1 is larger than each of the interval K3 between the third axis A1 and the fourth axis B1 and the interval K4 between the fifth axis C1 and the sixth axis D1. Therefore, the same liquids ejected from the respective nozzles of the second nozzle row B and the third nozzle row C are less likely to be influenced by each other than, for example, the same liquids ejected from the respective nozzles of the first nozzle row A and the second nozzle row B. Therefore, even when solid printing is performed while high-resolution printing is enabled by arranging the second nozzle row B and the third nozzle row C so as to be shifted by half a pitch such that the same liquids are ejected from the second nozzle row B and the third nozzle row C to form a single ruled line, it is possible to suppress the wind ripples described above and achieve the size reduction of the liquid ejecting head 1.

Further, as described above, the first nozzle row A, the second nozzle row B, the third nozzle row C, and the fourth nozzle row D are arranged in this order in the Y2 direction, and thus, the second nozzle row B and the third nozzle row C are interposed between the first nozzle row A and the fourth nozzle row D on the Y axis. Therefore, the interval K1 is larger than the interval K2. Therefore, the liquids ejected from the respective nozzles of the first nozzle row A and the fourth nozzle row D are less likely to be influenced by each other than the liquids ejected from the respective nozzles of the second nozzle row B and the third nozzle row C. As a result, the liquids ejected from the respective nozzles of the first nozzle row A and the fourth nozzle row D are least likely to cause the wind ripples described above.

Meanwhile, since the interval K1 is larger than the interval K2, the second nozzle row B and the third nozzle row C are closer to each other than the first nozzle row A and the fourth nozzle row D are. Therefore, the liquids ejected from the respective nozzles of the second nozzle row B and the third nozzle row C have less landing deviation on the medium M than the liquids ejected from the respective nozzles of the first nozzle row A and the fourth nozzle row D.

In addition, in the present embodiment, the Y axis as the second axis and the X axis as the seventh axis are orthogonal to each other when viewed in the Z1 direction, which is the direction along the Z axis as the first axis. Each of the third axis A1, the fourth axis B1, the fifth axis C1, and the sixth axis D1 intersects the Y axis and the X axis when viewed in the Z1 direction. Therefore, the row directions of the first nozzle row A, the second nozzle row B, the third nozzle row C, and the fourth nozzle row D each intersect a movement direction of the medium M or the liquid ejecting head 1 when viewed in the Z1 direction. When each nozzle row S is inclined with respect to the movement direction in this way, an effect of reducing the wind ripples described above can be particularly significantly achieved.

As described above, the plurality of nozzles N of the fifth nozzle row E and the plurality of nozzles N of the eighth nozzle row H eject the black ink as the “second liquid”. The plurality of nozzles N of the sixth nozzle row F and the plurality of nozzles N of the seventh nozzle row G eject the white ink as the “first liquid”.

As illustrated in FIG. 5, positions of the plurality of nozzles N of the fifth nozzle row E and the plurality of nozzles N of the eighth nozzle row H along the X axis, which is the “seventh axis”, are shifted by half a pitch. A line segment E0 along the Y axis passing through the center of any one of the plurality of nozzles N of the fifth nozzle row E when viewed in the Z1 direction, and a line segment H0 along the Y axis passing through the center of any one of the plurality of nozzles N of the eighth nozzle row H when viewed in the Z1 direction are illustrated. Positions of the line segments E0 and H0 along the X axis are shifted. For example, when a straight line along the X axis is printed on the medium M by droplets ejected from the plurality of nozzles N of the fifth nozzle row E and droplets ejected from the plurality of nozzles N of the eighth nozzle row H, dots formed by the droplets ejected from the plurality of nozzles N of the fifth nozzle row E and dots formed by the droplets ejected from the plurality of nozzles N of the eighth nozzle row H are printed so as to be alternately arranged along the X axis.

Positions of the plurality of nozzles N of the sixth nozzle row F and the plurality of nozzles N of the seventh nozzle row G along the X axis, which is the “seventh axis”, are shifted by half a pitch. A line segment F0 along the Y axis passing through the center of any one of the plurality of nozzles N of the sixth nozzle row F when viewed in the Z1 direction, and a line segment G0 along the Y axis passing through the center of any one of the plurality of nozzles N of the seventh nozzle row G when viewed in the Z1 direction are illustrated. Positions of the line segments F0 and G0 along the X axis are shifted. For example, when a straight line along the X axis is printed on the medium M by droplets ejected from the plurality of nozzles N of the sixth nozzle row F and droplets ejected from the plurality of nozzles N of the seventh nozzle row G, dots formed by the droplets ejected from the plurality of nozzles N of the sixth nozzle row F and dots formed by the droplets ejected from the plurality of nozzles N of the seventh nozzle row G are printed so as to be alternately arranged along the X axis.

Whether or not to perform ejection from the plurality of nozzles N belonging to the seventh nozzle row G, the eighth nozzle row H, the fifth nozzle row E, and the sixth nozzle row F is selected as appropriate, and for example, a desired color is formed on the medium M. For example, a single ruled line is formed on the medium M by the liquids ejected from the plurality of nozzles N belonging to the seventh nozzle row G, the eighth nozzle row H, the fifth nozzle row E, and the sixth nozzle row F.

For example, a resolution in the direction along the X axis achieved by the liquid ejected from the plurality of nozzles N belonging to the seventh nozzle row G is 600 dpi, and a resolution in the direction along the X axis achieved by the liquid ejected from the plurality of nozzles N belonging to the sixth nozzle row F is 600 dpi. In this case, the plurality of nozzles N of the seventh nozzle row G and the plurality of nozzles N of the sixth nozzle row F are shifted by half a pitch on the X axis, so that the seventh nozzle row G and the sixth nozzle row F can achieve a resolution of 1200 dpi together. Therefore, the seventh nozzle row G and the sixth nozzle row F can form a ruled line with a resolution of 1200 dpi on the medium M.

Similarly, for example, a resolution in the direction along the X axis achieved by the liquid ejected from the plurality of nozzles N belonging to the eighth nozzle row His 600 dpi, and a resolution in the direction along the X axis achieved by the liquid ejected from the plurality of nozzles N belonging to the fifth nozzle row E is 600 dpi. In this case, the plurality of nozzles N of the eighth nozzle row H and the plurality of nozzles N of the fifth nozzle row E are shifted by half a pitch on the X axis, so that the eighth nozzle row H and the fifth nozzle row E can achieve a resolution of 1200 dpi together. Therefore, the eighth nozzle row H and the fifth nozzle row E can form a ruled line with a resolution of 1200 dpi on the medium M.

As described above, in the seventh nozzle row G and the sixth nozzle row F that eject the same “first liquid”, the plurality of nozzles N of the seventh nozzle row G and the plurality of nozzles N of the sixth nozzle row F are shifted by half a pitch on the X axis, and thus, the resolution can be increased. Similarly, in the eighth nozzle row H and the fifth nozzle row E that eject the same “second liquid”, the plurality of nozzles N of the eighth nozzle row H and the plurality of nozzles N of the fifth nozzle row E are shifted by half a pitch on the X axis, and thus, the resolution can be increased.

Further, an interval K6 between the fourth axis B1 and an eighth axis G1 is larger than each of the interval K3 between the third axis A1 and the fourth axis B1 and an interval K7 between the eighth axis G1 and a ninth axis H1. Therefore, the same liquids ejected from the respective nozzles of the seventh nozzle row G and the sixth nozzle row F are less likely to be influenced by each other than, for example, the same liquids ejected from the respective nozzles of the first nozzle row A and the second nozzle row B. Therefore, even when solid printing is performed while high-resolution printing is enabled by arranging the seventh nozzle row G and the sixth nozzle row F so as to be shifted by half a pitch such that the same liquids are ejected from the seventh nozzle row G and the sixth nozzle row F to form a single ruled line, it is possible to suppress the wind ripples described above and achieve the size reduction of the liquid ejecting head 1.

An interval K5 between the third axis A1 and the ninth axis H1 is larger than each of the interval K3 between the third axis A1 and the fourth axis B1 and the interval K7 between the eighth axis G1 and the ninth axis H1. For this reason, the same liquids ejected from the respective nozzles of the eighth nozzle row H and the fifth nozzle row E are less likely to be influenced by each other than, for example, the same liquids ejected from the respective nozzles of the first nozzle row A and the second nozzle row B. Therefore, even when solid printing is performed while high-resolution printing is enabled by arranging the eighth nozzle row H and the fifth nozzle row E so as to be shifted by half a pitch such that the same liquids are ejected from the eighth nozzle row H and the fifth nozzle row E to form a single ruled line, it is possible to suppress the wind ripples described above and achieve the size reduction of the liquid ejecting head 1.

Further, as described above, the seventh nozzle row G, the eighth nozzle row H, the fifth nozzle row E, and the sixth nozzle row F are arranged in this order in the Y2 direction, and thus, the eighth nozzle row H and the fifth nozzle row E are interposed between the seventh nozzle row G and the sixth nozzle row F on the Y axis. Therefore, the interval K6 is larger than the interval K5. Therefore, the liquids ejected from the respective nozzles of the seventh nozzle row G and the sixth nozzle row F are less likely to be influenced by each other than the liquids ejected from the respective nozzles of the eighth nozzle row H and the fifth nozzle row E. As a result, the liquids ejected from the respective nozzles of the seventh nozzle row G and the sixth nozzle row F are least likely to cause the wind ripples described above.

Meanwhile, since the interval K6 is larger than the interval K5, the eighth nozzle row H and the fifth nozzle row E are closer to each other than the sixth nozzle row F and the seventh nozzle row G are. Therefore, the eighth nozzle row H and the fifth nozzle row E are close to each other. Therefore, the liquids ejected from the respective nozzles of the eighth nozzle row H and the fifth nozzle row E have less landing deviation on the medium M than the liquids ejected from the respective nozzles of the seventh nozzle row G and the sixth nozzle row F.

Furthermore, in the present embodiment, the nozzle rows S included in all the head chips 3b of the head unit 10b are arranged as the first to eighth nozzle rows A to G as described above. Therefore, the effect of suppressing the wind ripples described above in the head unit 10b can be achieved over the entire area of the medium M. Not all the head chips 3b of the head unit 10b have to have the nozzle rows S arranged as the first to eighth nozzle rows A to G as described above.

As described above, the “first liquid” is the white ink. That is, the liquid ejected from each of the nozzles N belonging to the first nozzle row A, the fourth nozzle row D, the eighth nozzle row H, and the fifth nozzle row E is the white ink. The white ink is more likely to cause the wind ripples than other inks. Therefore, the effect of suppressing the occurrence of the wind ripples described above can be significantly achieved by using the white ink as the “first liquid”.

For example, the “second liquid” may be white. That is, the liquid ejected from each of the nozzles N belonging to the second nozzle row B and the third nozzle row C may be the white ink. As described above, the interval K2 is larger than the interval K3. Therefore, an influence of the wind ripples when the white ink is ejected from each of the nozzles N of the second nozzle row B and the third nozzle row C is less than that when the white ink is ejected from each of the nozzles of the first nozzle row A and the second nozzle row B. Therefore, it is beneficial for the “second liquid” to be white. From the above viewpoint, the liquid ejected from each of the nozzles N belonging to the eighth nozzle row H and the fifth nozzle row E may be the white ink.

Furthermore, the first head chip 3b1, the second head chip 3b2, and the third head chip 3b3 described above may be arranged in the same chip group module 15b, or some of the first head chip 3b1, the second head chip 3b2, and the third head chip 3b3 may be arranged in different chip group modules 15b.

### A6. Arrangement of Nozzles N in Head Chip 3c

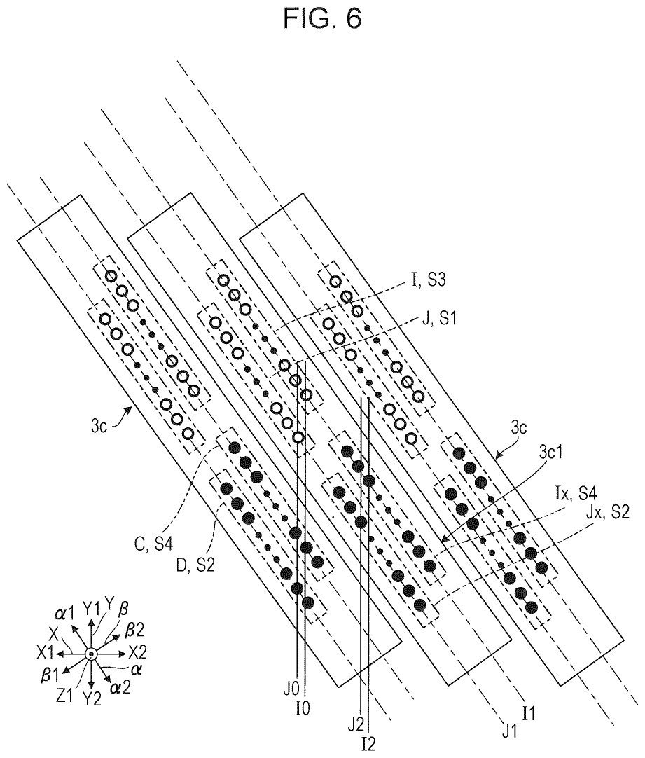

FIG. 6 is a view illustrating some of the plurality of head chips 3c included in the head unit 10c. In FIG. 6, the nozzles N are colored differently depending on the type of the liquid to be ejected to facilitate understanding. Specifically, in FIG. 6, the nozzles N that eject the green ink are illustrated in white, and the nozzles N that eject the cyan ink are illustrated in black.

As illustrated in FIG. 6, among the plurality of head chips 3c included in the head unit 10c, any one of the head chips 3c is referred to as a “fourth head chip 3c1”. In the fourth head chip 3c1, the nozzle row S3 is a “ninth nozzle row I”, and the nozzle row S1 is a “tenth nozzle row J”. In the fourth head chip 3c1, the nozzle row S4 is a “ninth nozzle row Ix”, and the nozzle row S2 is a “tenth nozzle row Jx”.

The ninth nozzle row I and the tenth nozzle row J are adjacent to each other on the a axis, and no other nozzle rows are interposed between the ninth nozzle row I and the tenth nozzle row J. Similarly, the ninth nozzle row Ix and the tenth nozzle row J are adjacent to each other on the α axis, and no other nozzle rows are interposed between the ninth nozzle row Ix and the tenth nozzle row J.

In the ninth nozzle rows I and Ix, a plurality of nozzles N are arranged along a tenth axis I1 parallel to the third axis A1. In the tenth nozzle rows J and Jx, a plurality of nozzles N are arranged along an eleventh axis J1 parallel to the third axis A1.

The plurality of nozzles N of the ninth nozzle row I and the plurality of nozzles N of the tenth nozzle row J eject the green ink as a “third liquid different from the first liquid and the second liquid”. In other words, the two adjacent ninth and tenth nozzle rows I and J along the α axis in a single fourth head chip 3c1 eject the same green ink. Positions of the plurality of nozzles N of the ninth nozzle row I and the plurality of nozzles N of the tenth nozzle row J along the X axis, which is the “seventh axis”, are shifted by half a pitch. A line segment I0 along the Y axis passing through the center of any one of the plurality of nozzles N of the ninth nozzle row I when viewed in the Z1 direction, and a line segment J0 along the Y axis passing through the center of any one of the plurality of nozzles N of the tenth nozzle row J when viewed in the Z1 direction are illustrated. Positions of the line segments I0 and J0 along the X axis are shifted.

In the ninth nozzle row I and the tenth nozzle row J that eject the same “third liquid”, the plurality of nozzles N of the ninth nozzle row I and the plurality of nozzles N of the tenth nozzle row J are shifted by half a pitch on the X axis, and thus, the resolution can be increased.

The ninth and tenth nozzle rows I and J are arranged along the α axis without any other nozzle rows interposed between the ninth and tenth nozzle rows I and J, and are close to each other. Therefore, the liquids ejected from the respective nozzles of the ninth nozzle row I and the tenth nozzle row J have less landing deviation on the medium M.

Similarly, the plurality of nozzles N of the ninth nozzle row Ix and the plurality of nozzles N of the tenth nozzle row Jx eject the cyan ink as the “third liquid different from the first liquid and the second liquid”. In other words, the two adjacent ninth and tenth nozzle rows Ix and Jx along the α axis in a single fourth head chip 3c1 eject the same cyan ink. Positions of the plurality of nozzles N of the ninth nozzle row Ix and the plurality of nozzles N of the tenth nozzle row Jx along the X axis, which is the “seventh axis”, are shifted by half a pitch. A line segment I2 along the Y axis passing through the center of any one of the plurality of nozzles N of the ninth nozzle row Ix when viewed in the Z1 direction, and a line segment J2 along the Y axis passing through the center of any one of the plurality of nozzles N of the tenth nozzle row Jx when viewed in the Z1 direction are illustrated. Positions of the line segments I2 and J2 along the X axis are shifted.

In the ninth nozzle row Ix and the tenth nozzle row Jx that eject the same “third liquid”, the plurality of nozzles N of the ninth nozzle row Ix and the plurality of nozzles N of the tenth nozzle row Jx are shifted by half a pitch on the X axis, and thus, the resolution can be increased.

The ninth and tenth nozzle rows Ix and Jx are arranged along the α axis without any other nozzle rows interposed between the ninth and tenth nozzle rows Ix and Jx, and are close to each other. Therefore, the liquids ejected from the respective nozzles of the ninth nozzle row Ix and the tenth nozzle row Jx have less landing deviation on the medium M. Therefore, printing accuracy is excellent.

In particular, color ink such as the green ink is less likely to cause the wind ripples than the white ink. The white ink has a larger pigment particle diameter and a higher pigment concentration as compared to the color ink, and is often used to form a base layer, and thus, mist is likely to be generated when droplets are ejected from all the nozzles at once, and the wind ripples are likely to become a problem. On the other hand, the color ink is often used to form an image, and thus, the ink is ejected from a selected nozzle rather than ejecting droplets from all the nozzles at once. Therefore, printing quality of the entire formed image can be improved by reducing the landing deviation of the color ink on the medium M. The same can apply to the overprint liquid and various reaction liquids. Therefore, each of the nozzle rows S in the head chips 3a, 3d, and 3e may have the same concept as that of the head chip 3c described above. In other words, the same type of liquid may be supplied to two nozzle rows S arranged along the α axis.

### B. Second Embodiment

The reference numerals used in the description of the first embodiment are used for elements having the same actions or functions as those of the first embodiment in a second embodiment exemplified below, and a detailed description of each element is omitted as appropriate.

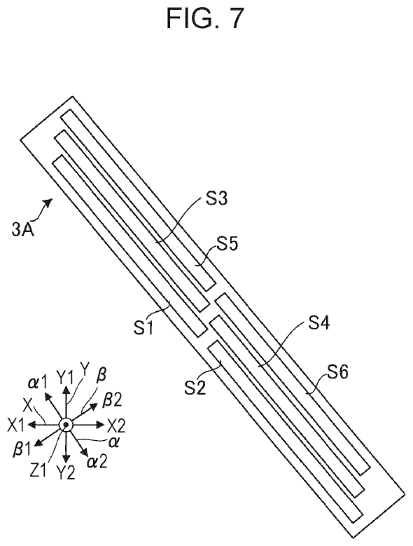

FIG. 7 is a bottom view schematically illustrating a head chip 3A in the second embodiment. As illustrated in FIG. 7, in the present embodiment, a single head chip 3A includes six nozzle rows S1, S2, S3, S4, S5, and S6. The six nozzle rows S are arranged in two rows along the β axis and three columns along the α axis. In each head chip 3A, the nozzle row S5 is positioned in the X2 direction with respect to the nozzle row S3. The nozzle row S6 is positioned in the X2 direction with respect to the nozzle row S4.

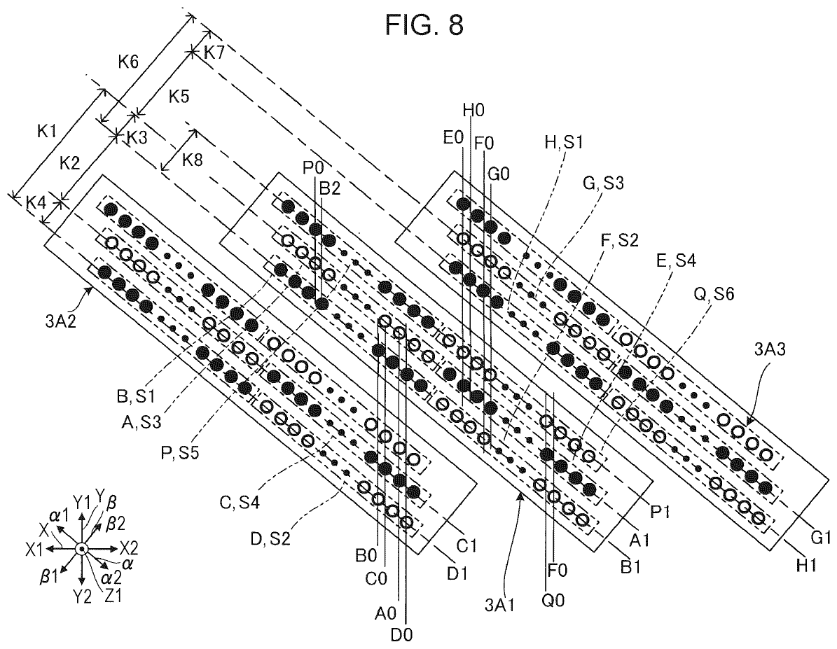

FIG. 8 is a view illustrating some of the plurality of head chips 3A in the second embodiment. The middle head chip 3A of three head chips 3A illustrated in FIG. 8 is a first head chip 3A1. The head chip 3A arranged on one side of the first head chip 3A1 in the X1 direction is referred to as a “second head chip 3A2”. The head chip 3A arranged on the other side of the first head chip 3A1 in the X2 direction is referred to as a “third head chip 3A3”.

In the first head chip 3A1, the nozzle row S3 is a “first nozzle row A”, the nozzle row S1 is a “second nozzle row B”, the nozzle row S4 is a “fifth nozzle row E”, the nozzle row S2 is a “sixth nozzle row F”, the nozzle row S5 is an “eleventh nozzle row P”, and the nozzle row S6 is a “twelfth nozzle row Q”. In the second head chip 3A2, the nozzle row S4 is a “third nozzle row C”, and the nozzle row S2 is a “fourth nozzle row D”. In the third head chip 3A3, the nozzle row S3 is a “seventh nozzle row G”, and the nozzle row S1 is an “eighth nozzle row H”.

The eleventh nozzle row P, the first nozzle row A, and the second nozzle row B are arranged in this order in the Y2 direction, which is a transport direction of a liquid ejecting head 1. Similarly, the twelfth nozzle row Q, the fifth nozzle row E, and the sixth nozzle row F are arranged in this order in the Y2 direction, which is the transport direction of the liquid ejecting head 1. In each of the eleventh nozzle row P and the twelfth nozzle row Q, a plurality of nozzles N are arranged along a twelfth axis P1 parallel to a third axis A1.

Similarly to the first embodiment, positions of a plurality of nozzles N of the first nozzle row A and a plurality of nozzles N of the fourth nozzle row D along the X axis are shifted by half a pitch. Positions of a plurality of nozzles N of the second nozzle row B and a plurality of nozzles N of the third nozzle row C along the X axis are shifted by half a pitch. Positions of a plurality of nozzles N of the fifth nozzle row E and a plurality of nozzles N of the eighth nozzle row H along the X axis are shifted by half a pitch. Positions of a plurality of nozzles N of the sixth nozzle row F and a plurality of nozzles N of the seventh nozzle row G along the X axis are shifted by half a pitch.

Positions of the plurality of nozzles N of the second nozzle row B and the plurality of nozzles N of the eleventh nozzle row P along the X axis are shifted by half a pitch. A line segment B2 along the Y axis passing through the center of any one of the plurality of nozzles N of the second nozzle row B when viewed in the Z1 direction, and a line segment P0 along the Y axis passing through the center of any one of the plurality of nozzles N of the eleventh nozzle row P when viewed in the Z1 direction are illustrated. Positions of the line segments B2 and P0 along the X axis are shifted.

Positions of the plurality of nozzles N of the sixth nozzle row F and the plurality of nozzles N of the twelfth nozzle row Q along the X axis are shifted by half a pitch. A line segment F0 along the Y axis passing through the center of any one of the plurality of nozzles N of the sixth nozzle row F when viewed in the Z1 direction, and a line segment Q0 along the Y axis passing through the center of any one of the plurality of nozzles N of the twelfth nozzle row Q when viewed in the Z1 direction are illustrated. Positions of the line segments F0 and Q0 along the X axis are shifted.

An interval K1 between the third axis A1 and a sixth axis D1 is larger than an interval K8 between the fourth axis B1 and the twelfth axis P1. Therefore, a combination of the first nozzle row A and the fourth nozzle row D is more effective in suppressing wind ripples than a combination of the second nozzle row B and the eleventh nozzle row P. Further, an interval K2 between the fourth axis B1 and a fifth axis C1 is larger than the interval K8 between the fourth axis B1 and the twelfth axis P1. Therefore, a combination of the second nozzle row B and the third nozzle row C is more effective in suppressing the wind ripples than a combination of the second nozzle row B and the eleventh nozzle row P. Furthermore, similarly to the first embodiment, the interval K1 is larger than the interval K2. Therefore, the combination of the first nozzle row A and the fourth nozzle row D is more effective in suppressing the wind ripples than the combination of the second nozzle row B and the third nozzle row C.

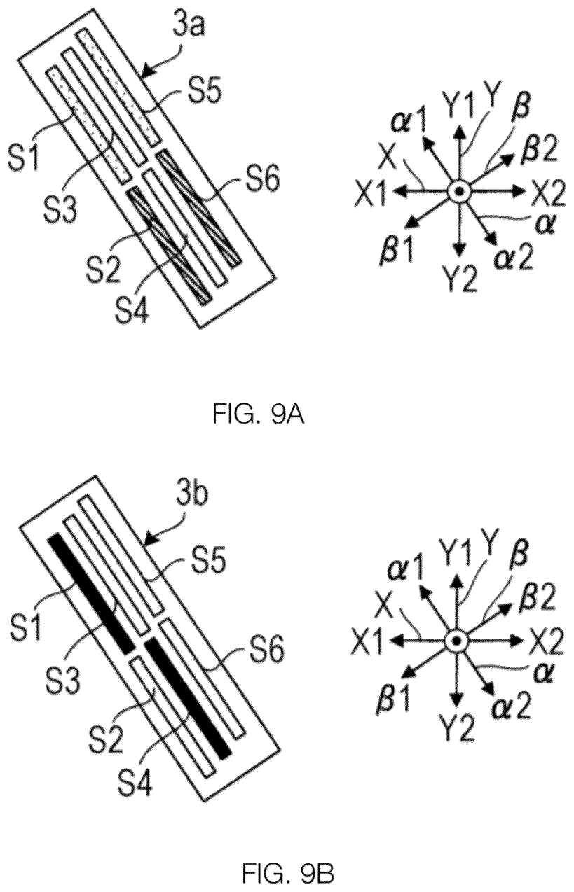

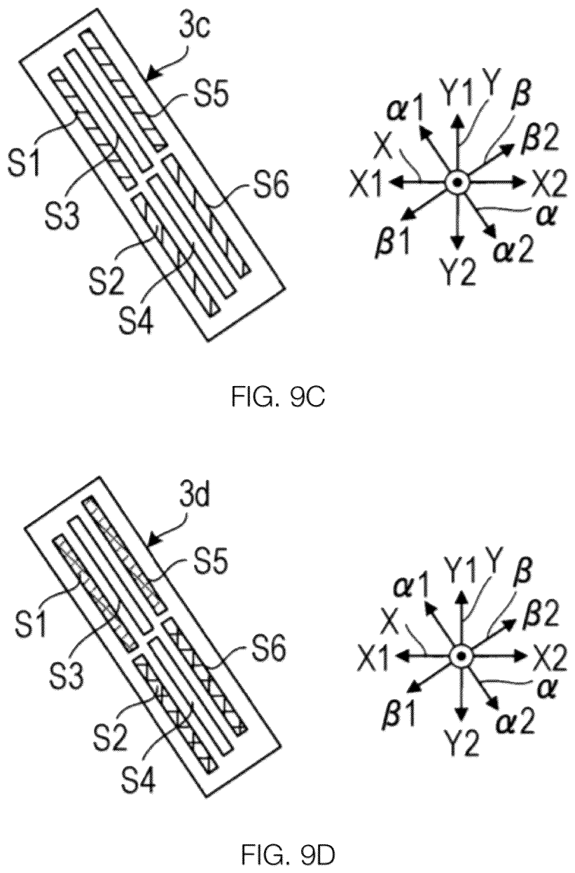

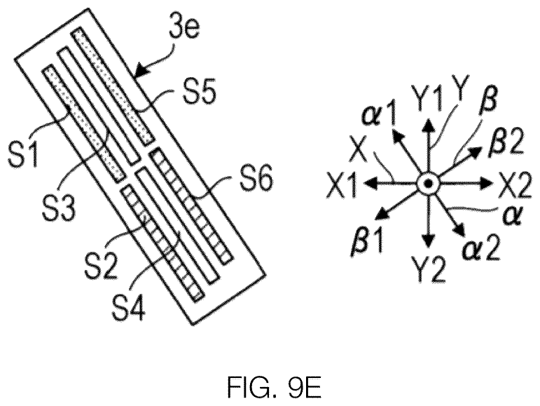

FIGS. 9A to 9E are views for describing examples of liquids ejected from the head chips 3A included in respective head units 10 in the second embodiment. Considering the suppression of the wind ripples based on the interval between the nozzle rows S, FIGS. 9A to 9E illustrate examples of the nozzle rows S used in the head chip 3A for each head unit 10 and a type of ink to be used.

In a head chip 3a illustrated in FIG. 9A, the nozzle rows S1, S5, S2, and S6 are used, and the nozzle rows S3 and S4 are not used. For example, a reaction liquid for a paper medium is ejected from the nozzle rows S1 and S5 of the head chip 3a. For example, a reaction liquid for a film-based medium is ejected from the nozzle rows S2 and S6 of the head chip 3a.

In a head chip 3b illustrated in FIG. 9B, the nozzle rows S1, S2, S3, and S4 are used, and the nozzle rows S5 and S6 are not used. For example, black ink is ejected as a “second liquid” from the nozzle rows S1 and S4 of the head chip 3b. White ink is ejected as a “first liquid” from the nozzle rows S2 and S3 of the head chip 3b.

In a head chip 3a illustrated in FIG. 9C, the nozzle rows S1, S5, S2, and S6 are used, and the nozzle rows S3 and S4 are not used. For example, green ink is ejected from the nozzle rows S1 and S5 of the head chip 3c. For example, cyan ink is ejected from the nozzle rows S2 and S6 of the head chip 3c.

In a head chip 3d illustrated in FIG. 9D, the nozzle rows S1, S5, S2, and S6 are used, and the nozzle rows S3 and S4 are not used. For example, orange ink is ejected from the nozzle rows S1 and S5 of the head chip 3d. For example, magenta ink is ejected from the nozzle rows S2 and S6 of the head chip 3d.

In a head chip 3e illustrated in FIG. 9E, the nozzle rows S1, S5, S2, and S6 are used, and the nozzle rows S3 and S4 are not used. For example, an overprint liquid is ejected from the nozzle rows S1 and S5 of the head chip 3e. For example, yellow ink is ejected from the nozzle rows S2 and S6 of the head chip 3e.

As described above, the same head chips 3A can be used in a plurality of head units 10 by selecting the nozzle row S to be used for each type of liquid. Therefore, after the plurality of head chips 3A are assembled as the liquid ejecting head 1, the liquid can be selected. Therefore, the liquid ejecting apparatus 100 has excellent usability.

Similarly to the first embodiment, in the example of FIG. 9, accuracy of an ink landing position is prioritized for color ink, and the suppression of the wind ripples is prioritized for white ink. Quality of a formed image can be improved by setting the arrangement of the nozzle row S such that a required effect can be obtained for each type of liquid as described above.

In the illustrated example, the nozzle row S5 is positioned in the X2 direction with respect to the nozzle row S3. However, for example, the nozzle row S5 may be positioned in the X1 direction with respect to the nozzle row S1. Similarly, the nozzle row S6 is positioned in the X2 direction with respect to the nozzle row S4. However, for example, the nozzle row S6 may be positioned in the X1 direction with respect to the nozzle row S2. As described above, the arrangement of the nozzle rows S5 and S6 is not limited to the example in FIG. 7.

### C. Modifications

Each embodiment exemplified above can be modified in various ways. Specific modified aspects that can be applied to each embodiment described above are described below by way of example.

### C1. First Modification

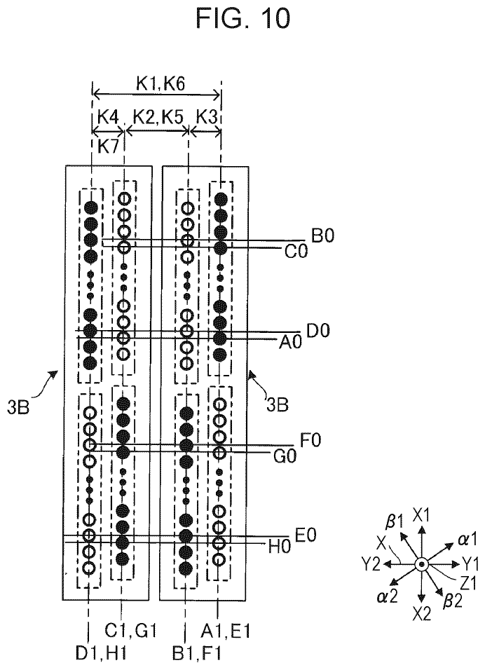

FIG. 10 is a view illustrating some of a plurality of head chips 3B in a first modification. In the example illustrated in FIG. 10, nozzle rows S of each head chip 3B are orthogonal to the Y2 direction, which is the transport direction of the liquid ejecting head 1. As described above, the row direction of the plurality of nozzle rows S of the head chip 3 with respect to the transport direction of the liquid ejecting head 1 is not particularly limited.

### C2. Other Modifications

In the above description, the “first liquid” is the white ink, and the “second liquid” is the black ink. However, the “first liquid” may be a liquid other than the white ink, and the “second liquid” may be a liquid other than the black ink. The “third liquid” may be, for example, the white ink or the black ink.

In each of the above embodiments, the carriage 231 on which the liquid ejecting head 1 is mounted reciprocates, but the carriage 231 does not have to be movable.

The liquid ejecting apparatus 100 exemplified in the embodiments described above may be employed in various devices such as a facsimile machine and a copying machine in addition to a device dedicated to printing, and the application of the present disclosure is not particularly limited. The use of the liquid ejecting apparatus is not limited to printing. For example, the liquid ejecting apparatus that ejects a solution of a coloring material is used as a producing apparatus that forms a color filter of a display device such as a liquid crystal display panel. Further, the liquid ejecting apparatus that ejects a solution of a conductive material is used as a producing apparatus that forms wiring or an electrode of a wiring substrate. Further, the liquid ejecting apparatus that ejects a solution of organic matter related to a living body is used as, for example, a producing apparatus that produces a biochip.

Although the present disclosure has been described above based on the exemplary embodiments, the present disclosure is not limited to the above-described embodiments. Further, a configuration of each portion according to the present disclosure can be substituted with an appropriate configuration that can implement the same functions as the above-described embodiments, and any appropriate configuration can also be added.

What is claimed is:

1. A liquid ejecting apparatus comprising:
a liquid ejecting head including a plurality of head chips that is configured to eject a liquid toward a medium along a first axis; and
a movement mechanism that is configured to move relative positions of the liquid ejecting head and the medium along a second axis intersecting the first axis, wherein
the plurality of head chips includes a first head chip and a second head chip arranged on one side of the first head chip,
the first head chip includes a first nozzle row in which a plurality of nozzles is arranged along a third axis intersecting the first axis and the second axis, and a second nozzle row in which a plurality of nozzles is arranged along a fourth axis parallel to the third axis,
the second head chip includes a third nozzle row in which a plurality of nozzles is arranged along a fifth axis parallel to the third axis, and a fourth nozzle row in which a plurality of nozzles is arranged along a sixth axis parallel to the third axis,
a position of the plurality of nozzles of the first nozzle row along a seventh axis orthogonal to the second axis is shifted by half a pitch from a position of the plurality of nozzles of the fourth nozzle row along the seventh axis,
the plurality of nozzles of the first nozzle row and the plurality of nozzles of the fourth nozzle row eject a first liquid,
a position of the plurality of nozzles of the second nozzle row along the seventh axis is shifted by half the pitch from a position of the plurality of nozzles of the third nozzle row along the seventh axis, and
the plurality of nozzles of the second nozzle row and the plurality of nozzles of the third nozzle row eject a second liquid of a type different from the first liquid.

2. The liquid ejecting apparatus according to claim 1, wherein
an interval between the third axis and the sixth axis is larger than each of an interval between the third axis and the fourth axis and an interval between the fifth axis and the sixth axis, and
an interval between the fourth axis and the fifth axis is larger than each of the interval between the third axis and the fourth axis and the interval between the fifth axis and the sixth axis.

3. The liquid ejecting apparatus according to claim 1, wherein
the second axis and the seventh axis are orthogonal to each other when viewed in a direction along the first axis, and
each of the third axis, the fourth axis, the fifth axis, and the sixth axis intersects the second axis and the seventh axis when viewed in the direction along the first axis.

4. The liquid ejecting apparatus according to claim 1, wherein
the plurality of head chips include a third head chip arranged on an opposite side of the first head chip from the one side,
the first head chip further includes a fifth nozzle row in which a plurality of nozzles is arranged along the third axis, and a sixth nozzle row in which a plurality of nozzles is arranged along the fourth axis,
the third head chip includes a seventh nozzle row in which a plurality of nozzles is arranged along an eighth axis parallel to the third axis, and an eighth nozzle row in which a plurality of nozzles is arranged along a ninth axis parallel to the third axis,
a position of the plurality of nozzles of the fifth nozzle row along the seventh axis is shifted by half a pitch from a position of the plurality of nozzles of the eighth nozzle row along the seventh axis,
the plurality of nozzles of the fifth nozzle row and the plurality of nozzles of the eighth nozzle row eject the second liquid,
a position of the plurality of nozzles of the sixth nozzle row along the seventh axis is shifted by half a pitch from a position of the plurality of nozzles of the seventh nozzle row along the seventh axis, and
the plurality of nozzles of the sixth nozzle row and the plurality of nozzles of the seventh nozzle row eject the first liquid.

5. The liquid ejecting apparatus according to claim 4, wherein
an interval between the third axis and the ninth axis is larger than each of an interval between the third axis and the fourth axis and an interval between the eighth axis and the ninth axis, and
an interval between the fourth axis and the eighth axis is larger than each of the interval between the third axis and the fourth axis and the interval between the eighth axis and the ninth axis.

6. The liquid ejecting apparatus according to claim 1, wherein
the plurality of head chips include a fourth head chip,
the fourth head chip includes a ninth nozzle row in which a plurality of nozzles is arranged along a tenth axis parallel to the third axis, and a tenth nozzle row in which a plurality of nozzles is arranged along an eleventh axis parallel to the third axis,
a position of the plurality of nozzles of the ninth nozzle row along the seventh axis is shifted by half a pitch from a position of the plurality of nozzles of the tenth nozzle row along the seventh axis, and
the plurality of nozzles of the ninth nozzle row and the plurality of nozzles of the tenth nozzle row eject a third liquid different from the first liquid and the second liquid.

7. The liquid ejecting apparatus according to claim 1, wherein
the first head chip further includes an eleventh nozzle row in which a plurality of nozzles is arranged along a twelfth axis parallel to the third axis,
a position of the plurality of nozzles of the second nozzle row along the seventh axis is shifted by half a pitch from a position of the plurality of nozzles of the eleventh nozzle row along the seventh axis,
the plurality of nozzles of the second nozzle row and the plurality of nozzles of the eleventh nozzle row are configured to eject a third liquid different from the first liquid and the second liquid,
an interval between the third axis and the sixth axis is larger than an interval between the fourth axis and the twelfth axis, and
an interval between the fourth axis and the fifth axis is larger than the interval between the fourth axis and the twelfth axis.

8. The liquid ejecting apparatus according to claim 1, wherein one of the first liquid and the second liquid is white ink.
